(19) United States
(12) Patent Application Publication
(10) Pub. No.: US 2024/0384846 A1
(43) Pub. Date: Nov. 21, 2024

(54) WATER LAMP CANDLESTICK STRUCTURE

(71) Applicant: HUIZHOU DICHENG ELECTRONIC TECHNOLOGY CO., LTD, Huizhou City (CN)

(72) Inventor: BINJIE PAN, Huizhou City (CN)

(21) Appl. No.: 18/317,110

(22) Filed: May 15, 2023

(51) Int. Cl. F21S 10/00; F21S 6/00; F21V 3/04

(52) U.S. Cl. CPC F21S 10/002; F21S 6/002; F21V 3/049

(57) ABSTRACT

Provided is a water lamp candlestick structure, including: a base, equipped with an electronic control unit inside; a water lamp body, arranged on the base, and being in a hollow pervious-to-light three-dimensional shape and hermetically containing flowable liquid; an outer cover, connected to the base and covering the water lamp body; a bearing seat, connected to the outer cover and having an accommodating part; and a light-emitting unit, electronically connected to the electronic control unit. According to the water lamp candlestick structure of the present disclosure, the water lamp body and the outer cover are respectively arranged on the base, meanwhile, the outer cover covers the water lamp body to protect the water lamp body to improve the protection effect of the water lamp candlestick structure, such that the water lamp candlestick structure is not easy to break in the manufacturing process and handling process and easy to collect.

### BACKGROUND

### Technical Field

The present disclosure relates a candlestick seat, in particularly to a water lamp candlestick structure.

### Related Art

At present, people focus on the living quality, requires a relaxed atmosphere and self space design sense in the design and layout of the living space. Design furnishings can be arranged with the help of general ornament, such as painting and calligraphy, lamp decoration, tablecloth, decoration, candlestick. The lamp decoration and candlelight of the candlestick can create an excellent atmosphere in space.

For example, as described in the U.S. Pat. No. 9,222,663 B1 of the applicant of this application, which has been approved, the water lamp with a top decoration mainly uses a motor to drive a magnetic rotating shaft to further drive a magnetic rotating member under magnetic attraction to rotate. Meanwhile, liquid inside the water lamp body is disturbed by the magnetic rotating member and shifting sheets to form a flow effect, and the flowing liquid is illuminated by the light-emitting assembly to form a candlestick lamp structure with dynamic light and shadow changes. Although the candlestick itself shows an effect with dynamic visual changes, the water lamp body generally uses glass or plastic products, so the water lamp body is fragile in the manufacturing process and transportation process and inconvenient to collect, which needs to be improved.

### SUMMARY

The present disclosure aims to provide a water lamp candlestick structure with an excellent protection effect, design sense and aestheticism.

To solve the above technical problems, the present disclosure can be implemented by adopting the following technical solutions:

A water lamp candlestick structure, comprising:
a base, equipped with an electronic control unit inside;
a water lamp body, arranged on the base, being in a hollow pervious-to-light three-dimensional shape and hermetically containing flowable liquid;
an outer cover, connected to the base and covering the water lamp body;
a bearing seat, connected to the outer cover and having an accommodating part; and
a light-emitting unit, electronically connected to the electronic control unit.

In an embodiment, the outer cover is pervious-to-light.

In an embodiment, the water lamp candlestick structure further comprises a water-stirring assembly, the water-stirring assembly comprising a driving member arranged in the base and a magnetic shifting member arranged in the water lamp body, the driving member being connected to the electronic control unit and having a magnetic rotating shaft, and the magnetic shifting member being magnetically attracted by the magnetic shaft and rotates accordingly, so that the liquid inside the water lamp body flows.

In an embodiment, the accommodating part is equipped with an illumination unit inside.

In an embodiment, a side wall of the outer cover has an irregular, angular, concave-convex shape, so that the outer cover can project a light effect corresponding to the shape.

In an embodiment, the water lamp candlestick structure further comprises a lamp cover arranged on an outer edge of the bearing seat.

In an embodiment, an insertion slot with an upward opening is arranged at a bottom of the accommodating part.

In an embodiment, the electronic control unit of the base further comprise a switch, the switch being a mechanical switch arranged on the base or a remote control switch with remote control.

In an embodiment, a plurality of shifting sheets is arranged on the magnetic shifting member.

In an embodiment, the plurality of shifting sheets is arranged in radial intervals.

The beneficial effects are as follow:

According to the water lamp candlestick structure of the present disclosure, the water lamp body and the outer cover are respectively arranged on the base, meanwhile, the outer cover covers the water lamp body to protect the water lamp body to improve the protection effect of the water lamp candlestick structure, such that the water lamp candlestick structure is not easy to break in the manufacturing process and handling process and easy to collect. Meanwhile, through the outer cover made of pervious-to-light materials, the light emitted by the light-emitting unit is refracted from the water lamp body and combined with the flowing liquid to form an effect with dynamic light and shadow changes, so that the water lamp candlestick has design sense and aestheticism.

### BRIEF DESCRIPTION OF THE DRAWINGS

FIG. 1 is a structure diagram I of a water lamp candlestick structure according to the present disclosure;

FIG. 2 is a structure diagram II of the water lamp candlestick structure according to the present disclosure;

FIG. 3 is a structure diagram III of the water lamp candlestick structure according to the present disclosure;

FIG. 4 is a structure diagram IV of the water lamp candlestick structure according to the present disclosure; and

FIG. 5 is a schematic diagram of transmission light and shadow of an outer cover of the water lamp candlestick structure according to the present disclosure.

### DETAILED DESCRIPTION

To make the above purposes, features and advantages of the present disclosure more apparent and understandable, the specific implementations of the present disclosure will be explained in detail below in conjunction with the accompanying drawings. Numerous specific details are elaborated in the following description to facilitate a full understanding of the present disclosure. However, the present disclosure can be implemented in many other ways that are different from those described herein, those skilled in the art can make similar improvements without violating the connotation of the present disclosure, so the present disclosure is not limited by the specific embodiments disclosed below.

It is to be noted that when an element is referred to as “fixed to” another element, it may be directly on another element or there may be an intermediate element. When an element is considered to be “connected to” another element, it may be directly connected to another element or there may be an intermediate element at the same time. On the contrary, when an element is referred to as “directly on” another element, there is no intermediate element. As used herein, the terms “vertical”, “horizontal”, “left”, “right”, and similar expressions are for illustrative purposes only.

Unless otherwise defined, all technical and scientific terms as used herein have the same meanings as those commonly understood by those skilled in the technical field of the present disclosure. As used herein, the terms in the specification of the present disclosure are only used to describe the specific implementation, not to limit the present disclosure. As used herein, the term “and/or” includes any and all combinations of one or more related listed items.

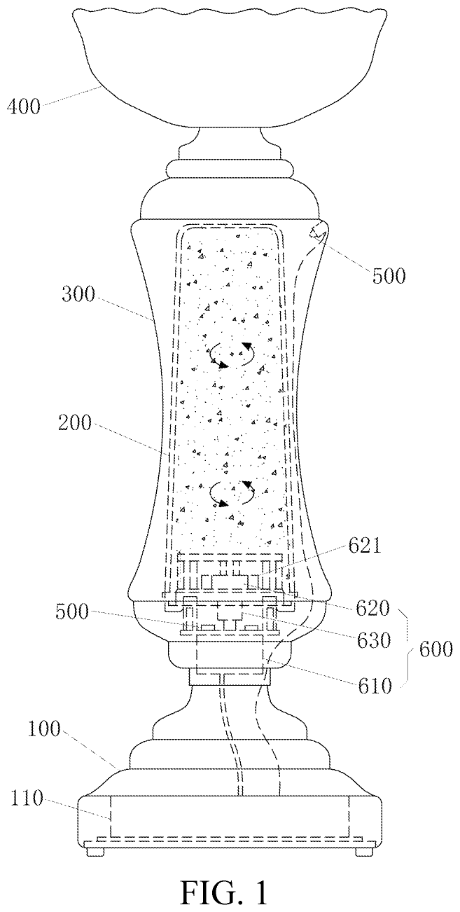

Please refer to FIG. 1, a water lamp candlestick structure, including:
a base 100, equipped with an electronic control unit 110 inside;
a water lamp body 200, arranged on the base 100, being in a hollow pervious-to-light three-dimensional shape and hermetically containing flowable liquid;
an outer cover 300, connected to the base 100 and covering the water lamp body 200;
a bearing seat 400, connected to the outer cover 300 and having an accommodating part 410; and
a light-emitting unit 500, electronically connected the electronic control unit 110.

Specifically, in this embodiment; the water lamp body 200 and the outer cover 300 are respectively arranged on the base 100. The outer cover 300 covers the water lamp body 200 when mounting. Meanwhile, the bearing seat 400 is arranged at a top of the outer cover 300, such that a candlestick structure is defined by the base 100, the water lamp body 200, the outer cover 300 and the bearing seat 400 together. The water lamp body 200 is covered by the outer cover 300 to form a protection structure, so that the overall protection effect of the water lamp candlestick structure is improved. Therefore, the water lamp candlestick structure is not easy to break in the manufacturing process and handling process and easy to collect. Of course, the bearing seat 400 is not limited to being arranged on a top of the outer cover 300, and it can be properly arranged according to the shape of the outer cover 300.

In addition, the water lamp candlestick structure is also equipped with a light-emitting unit 500, while the light-emitting unit 500 can be arranged in the base 100 to illuminate the water lamp body 200. Of course, the light-emitting unit may also be arranged above or on one side of the water lamp body 200. For example, the light-emitting unit can be fixed on an inner wall of the outer cover 300, and is electronically connected to the electronic control unit 110 through a wire. Moreover, the light-emitting unit 500 may also be arranged in the base 100 and above or on one side of the water lamp body 200 at the same. The specific arrangement way of the light-emitting unit is not limited. The light-emitting unit 500 can be controlled to emit light through the electronic control unit 110, thereby illuminating the water lamp body 200. Then, the light is refracted by the liquid inside the water lamp body 200. Finally, the light can be projected outward from the pervious-to-light outer cover 300. In this way, the water lamp candlestick structure has an effect with light and shadow changes, so that the water lamp candlestick structure has the design sense and aestheticism

Because the connecting wire is arranged inside the outer cover 300, the connecting wire can be effectively protected to avoid the fracture of connection.

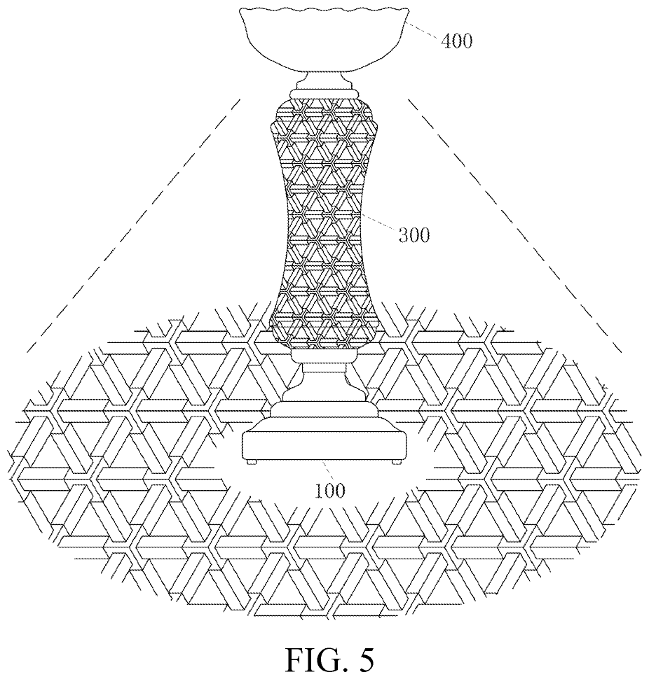

Please refer to FIG. 5, the outer cover 300 may be made of pervious-to-light materials such as acrylic, copolyester, and polycarbonate, and may also be made of metal materials. The materials of the outer cover are not limited in this embodiment. When using the metal materials, since the metal materials is generally not pervious to light, the outer cover 300 made of the metal materials may be hollowed. Through the hollow, the light can also be projected outward from the outer cover 300. When the outer cover 300 is made of acrylic, copolyester, or polycarbonate, a side wall of the outer cover 300 can be shaped into an angular, concave-convex, irregular shape. The shape is not limited, so through various design shapes, the outer cover 300 can transmit light and shadow corresponding to its side wall shape, making the light effect more unique.

Of course, when the outer cover 300 is made of the pervious-to-light materials, it is impossible to directly observe the water lamp body 200 inside the outer cover 300 without controlling the light-emitting unit 500 to emit light. When the electronic control unit 110 drives the light-emitting unit 500 to emit light, the light is projected outward from the outer cover 300 through the illumination of the light-emitting unit 500, such that a user can dimly observe the water lamp body 200 inside the outer cover 300, thus creating a mysterious atmosphere for the water lamp candlestick structure and increasing the design sense and aestheticism of the water lamp candlestick.

To make the water lamp candlestick more dynamic, a water-stirring assembly 600 is further included. The water-stirring assembly 600 includes a driving member 610 arranged in the base 100 and a magnetic shifting member 620 arranged in the water lamp body 200. The driving member 610 is connected to the electronic control unit 110, and the driving member 610 has a magnetic rotating shaft 630. The magnetic shifting member 620 is magnetically attracted by the magnetic rotating shaft 630 and rotates accordingly, so that the liquid inside the water lamp body 200 flows.

When the light-emitting unit 500 illuminates the water lamp body 200, the driving member 610 (motor) will drive the magnetic rotating shaft 630 to rotate. When the magnetic rotating shaft 630 rotates, the magnetic shifting member 620 inside the water lamp body 200 is driven to rotate due to the magnetic attraction principle, thereby stirring the liquid inside the water lamp body 200. By the stirred liquid and the illuminating with the light-emitting unit 500, the water lamp candlestick structure is finally formed an effect with dynamic light and shadow changes, so that the water lamp candlestick structure has the design sense and aestheticism.

A plurality of shifting sheets 621 is arranged on the magnetic shifting member 620, and the plurality of shifting sheets 621 is arranged in radial intervals. The liquid inside the water lamp body 200 can be better stirred by the plurality of shifting sheets 621 arranged in radial intervals.

To control the effect with dynamic light and shadow changes of the water lamp candlestick structure, the electronic control unit 110 of the base 100 further includes a switch (not shown). The switch is a mechanical switch arranged on the base 100 or a remote control switch with remote control. The mechanical switch or the remote control switch is used to control a power supply of the electronic control unit 110, so that the control over the light-emitting unit 500 and the driving member 610 is achieved.

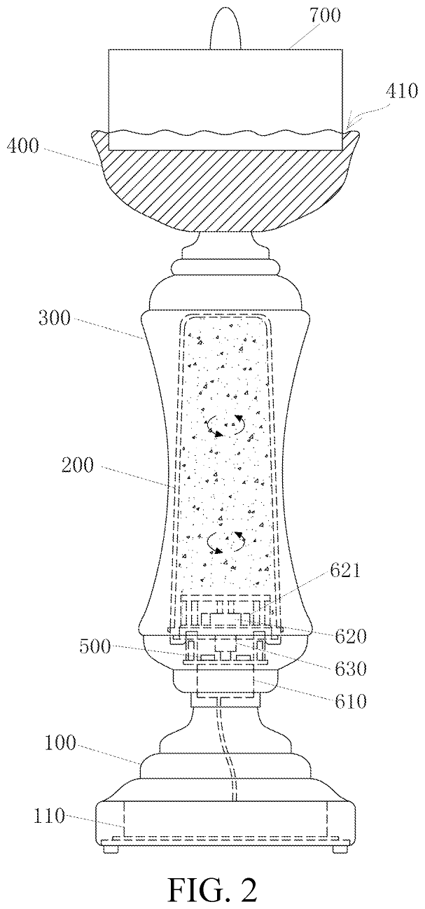

Please refer to FIG. 2 to FIG. 4, to achieve the candlestick structure with an illumination function, the bearing seat 400 has an accommodating part 410. The accommodating part 410 is equipped with an illumination unit 700 inside. The illumination unit 700 may be a non-electronic light-emitting device such as a candle and an oil lamp, and the illumination unit may also be an electronic light-emitting device such as an incandescent lamp, an LED, and an LED patch lamp.

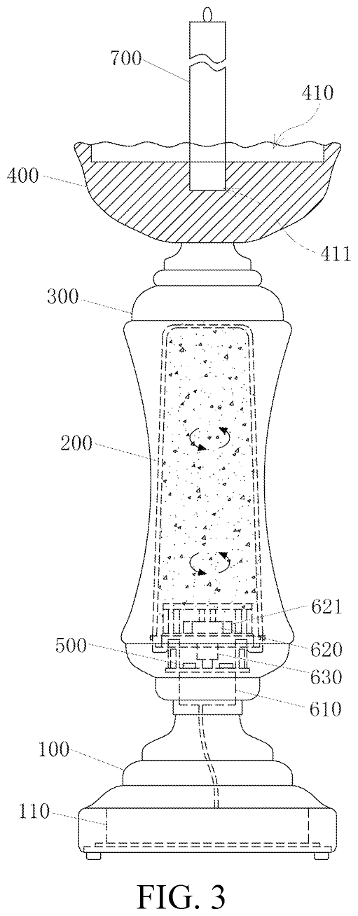

Please refer to FIG. 2 and FIG. 3, when the illumination unit 700 adopts the non-electronic light-emitting device, such as the candles and the oil lamp, it may be directly fixed in the accommodating part. Of course, due to different types of candles and their diameter sizes, an insertion slot 411 with an upward opening can be arranged at a bottom of the accommodating part 410. By using the accommodating part 410 or the insertion slot 411 inside the accommodating part 410, different types of candles can be placed, thus improving the practicality of the water lamp candlestick structure.

In addition, since the non-electronic light-emitting devices or the electronic light-emitting device generates heat, the accommodating part 410 of the bearing seat 400 is made of a heat-resistant material.

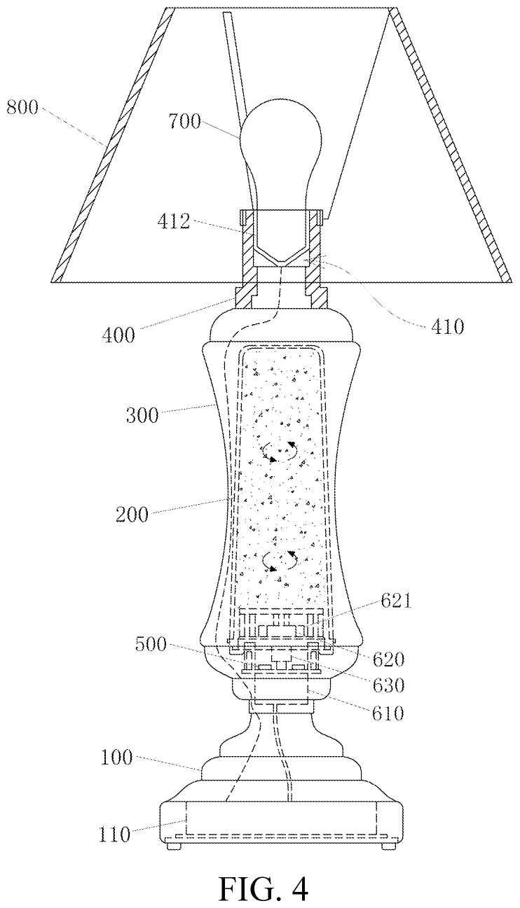

Please refer to FIG. 4, when the illumination unit 700 uses the electronic light-emitting device such as the incandescent lamp, the LED, or the LED patch lamp, in order to facilitate its mounting, a mounting seat 412 is also arranged in the accommodating part 410. The mounting seat 412 is electrically connected to the electronic control unit 110, and the illumination unit 700 is also electrically connected to the mounting seat 412. The on and off of the electronic light-emitting device is controlled through the electronic control unit 110.

Finally, the water lamp candlestick structure further includes a lamp cover 800 fixed on the outer edge of the bearing seat 400. This embodiment does not limit the way in which the lamp cover 800 is fixed, which may be nested, erected, fixed with screws, and the like.

The above shows and describes the basic principles, main features, and advantages of the present disclosure. Those skilled in the art can smoothly implement the present disclosure according to the accompany drawings of the specification and the descriptions above. However, any equivalent changes, modifications and evolutions made by those skilled in the art, without departing from the scope of the technical solution of the present disclosure, by utilizing the disclosed technical content, are all equivalent embodiments of the present disclosure. Meanwhile, any equivalent changes, modifications and evolutions to the above embodiments based on the substantive technology of the present disclosure are still within the protection scope of the technical solution of the present disclosure.

1. A water lamp candlestick structure, comprising:
a base, equipped with an electronic control unit inside;
a water lamp body, arranged on the base, being in a hollow pervious-to-light three-dimensional shape and hermetically containing flowable liquid;
an outer cover, connected to the base and covering the water lamp body;
a bearing seat, connected to the outer cover and having an accommodating part; and
a light-emitting unit, electronically connected to the electronic control unit;
wherein a side wall of the outer cover has an irregular, angular, concave-convex shape, so that the outer cover can project a light effect corresponding to the shape;
wherein the electronic control unit of the base further comprises a switch, and the switch is a remote control switch with remote control.

2. The water lamp candlestick structure according to claim 1, wherein the outer cover is pervious-to-light.

3. The water lamp candlestick structure according to claim 1, further comprising a water-stirring assembly, the water-stirring assembly comprising a driving member arranged in the base and a magnetic shifting member arranged in the water lamp body, the driving member being connected to the electronic control unit and having a magnetic rotating shaft, and the magnetic shifting member being magnetically attracted by the magnetic shaft and rotates accordingly, so that the liquid inside the water lamp body flows.

4. The water lamp candlestick structure according to claim 1, wherein the accommodating part is equipped with an illumination unit inside.

5. (canceled)

6. The water lamp candlestick structure according to claim 1, further comprising a lamp cover arranged on an outer edge of the bearing seat.

7. The water lamp candlestick structure according to claim 1, wherein an insertion slot with an upward opening is arranged at a bottom of the accommodating part.

8. (canceled)

9. The water lamp candlestick structure according to claim 3, wherein a plurality of shifting sheets is arranged on the magnetic shifting member.

10. The water lamp candlestick structure according to claim 9, wherein the plurality of shifting sheets is arranged in radial intervals.
